(19) United States
(12) Patent Application Publication
(10) Pub. No.: US 2008/0078144 A1
(43) Pub. Date: Apr. 3, 2008

(54) CLOSING HEAD FOR AN AUTOMATIC CAPPING MACHINE

(76) Inventor: Sergio Cirio, Canelli (Asti) (IT)

Correspondence Address: PATTERSON & SHERIDAN, L.L.P., 3040 POST OAK BOULEVARD, SUITE 1500, HOUSTON, TX, 77056, US

(21) Appl. No.: 11/864,456

(22) Filed: Sep. 28, 2007

(30) Foreign Application Priority Data
Sep. 29, 2006 (IT) TO2006A000699

(51) Int. Cl. B67B 3/10

(52) U.S. Cl. 53/359

(57) ABSTRACT

Closing head for an automatic capping machine, including, a support movable along a vertical direction between a lifted position and a lowered position, a rotating shaft carried by said support, movable together with this latter along said vertical direction and rotatable with respect to the support around a vertical axis, a cap gripping member carried at the lower end of said rotating shaft, and a sleeve fixed with respect to said support and coaxial with respect to the rotating shaft, the sleeve forming, around a part of the rotating shaft, a sealed chamber containing a sanifying liquid.

### CROSS-REFERENCE TO RELATED APPLICATIONS

This application claims benefit of Italian patent application number TO2006A000699, filed Sep. 29, 2006, which is herein incorporated by reference.

### BACKGROUND OF THE INVENTION

1. Field of the Invention

The present invention relates to a closing head for an automatic capping machine, suitable for applying screw or pressure caps to containers.

2. Description of the Related Art

A closing head of a known type for applying screw caps generally includes a support movable along a vertical direction between a lifted position and a lowered position, a rotating shaft carried by said support, movable together with this latter along said vertical direction and rotatable with respect to the support around a vertical axis, and a gripping member for caps carried at the lower end of the rotating shaft.

In capping machines intended for the food industry, there is the need of ensuring high hygienic conditions in the bottling area. In particular, there is the need of insulating the application zone of the caps from the motion transmission zone of the screwing head, for avoiding traces of contaminants existing in the motion transmission zone from reaching the zone in which caps are applied to containers.

### SUMMARY OF THE INVENTION

The object of the present invention is to provide a closing head for an automatic capping machine which allows to obtain a better insulation between the bottling area and the motion transmission area.

### BRIEF DESCRIPTION OF THE DRAWINGS

According to the present invention, this object is attained by a closing head having the features forming the subject of claim 1.

Features and advantages of the present invention will result apparent during the detailed following description, given purely by way of not limiting example, in which:

FIG. 1 is a partly sectioned side view of a closing head according to the present invention in a lowered position,

FIG. 2 is a view similar to FIG. 1 showing the closing head in a lifted position,

FIG. 3 is an enlarged axial section of the part shown by the arrow III in FIG. 1, and

FIG. 4 is an enlarged detail of the part shown by the arrow IV in FIG. 3.

### DETAILED DESCRIPTION

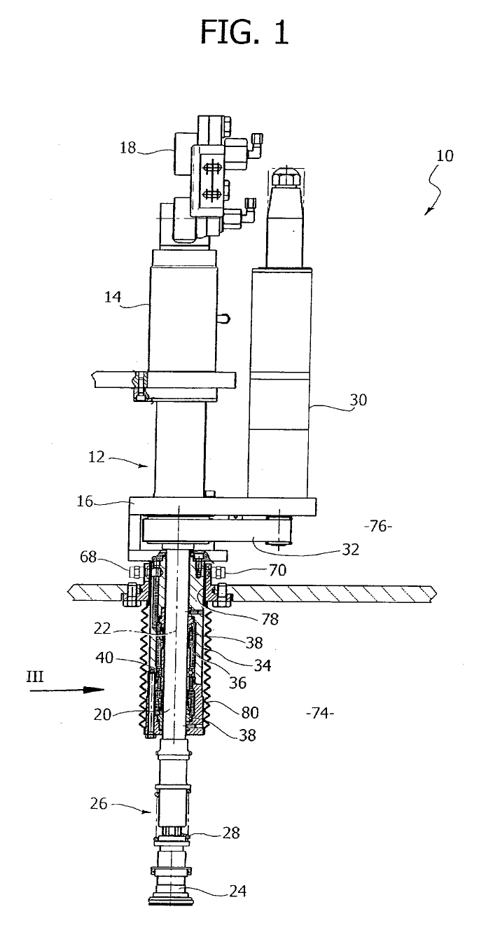

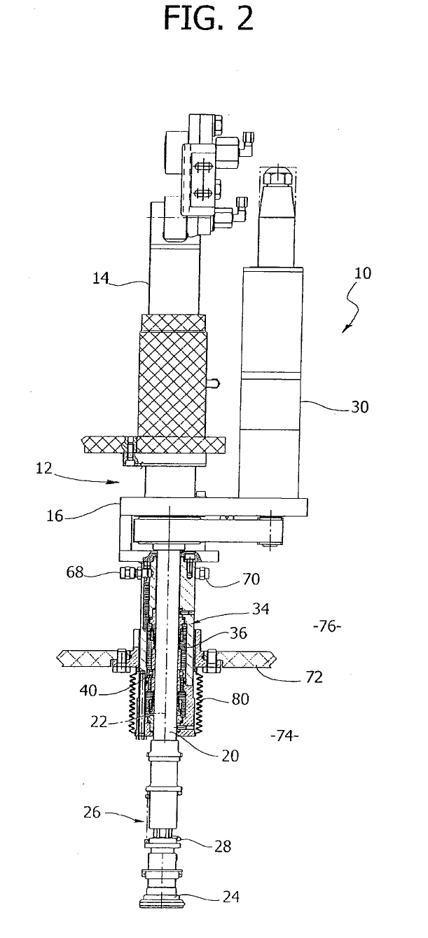

With reference to FIG. 1, a closing head according to the present invention, intended for being mounted on an automatic capping machine, for example of a carousel-like type, is indicated by 10. The closing head 10 includes a support 12 having a movement along a vertical rectilinear direction, between a lowered position shown in FIG. 1 and a lifted position shown in FIG. 2. The support 12 slides in a jacket 14 extending in a vertical direction and is fixed at its lower end to a movable flange 16. At the upper end of the support 12, an element 18 which controls the movement in the vertical direction is arranged. In the example shown in the figures, such control element consists of a roller 18 co-operating with a cam (not shown).

The vertically movable support 12 carries a rotating shaft 20 rotatable with respect to the support 12 around a vertical axis 22. The rotating shaft 20 carries at its lower end a cap gripping element 24. Preferably, the gripping element 24 is connected to the rotating shaft 20 by means of a compensation resilient device 26 which allows an axial displacement of the gripping element 24 relative to the rotating shaft 20 against the action of a spring 28.

In the embodiment shown in the figures, the rotating shaft 20 is rotated with respect to the support 12 by means of a motor 30 carried by the flange 16 integral with the support 12. The motor 30 is arranged with its own longitudinal axis parallel to the rotation axis 22 and is connected to the shaft 20 by means of a drive belt 32.

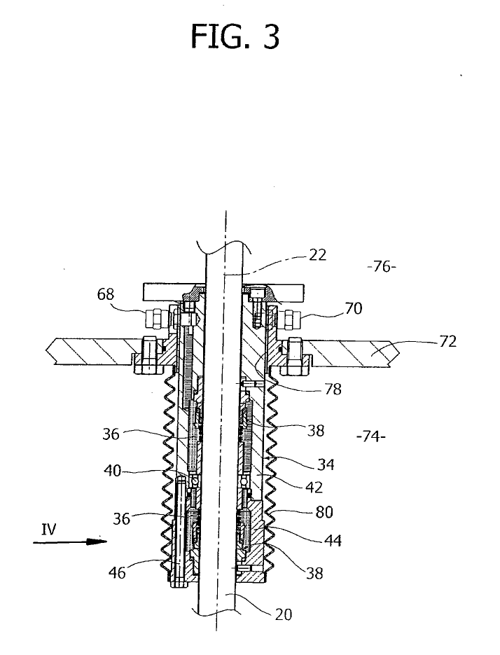

With particular reference to FIG. 3, the head 10 according to the present invention includes a sleeve 34 coaxial relative to the rotating shaft 20 and fixed relative to the support 12. The sleeve 34 defines a chamber 36 which surrounds a part of the rotating shaft 20 and is filled with a sanifying liquid. The chamber 36 is closed by two very high-precision mechanical sealings 38 (or other kind of sealings) which ensure the tight closure of the chamber 36. In the example shown in the figures, a roll bearing 40 is provided between the sleeve 34 and the rotating shaft 20. Preferably, the two sealings 38 are placed on opposite sides with respect to the bearing 40. The chamber 36 containing the sanifying liquid extends in an axial direction between the two sealings 38 and contains the bearing 40.

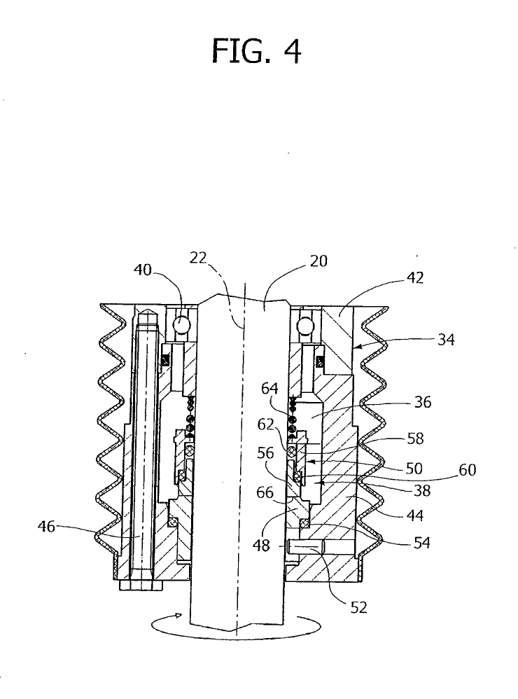

With reference to FIGS. 3 and 4, the sleeve 34, due to constructive reasons, is formed by an upper part 42 and a lower part 44 fixed together by axial screws 46 (only one of which is visible in the figures).

With reference to FIG. 4, each mechanical sealing 38 includes a fixed part 48 fastened to the sleeve 34 and a rotating part 50 fastened to the rotating shaft 20. The fixed part 48 is fastened to the part 44 of the sleeve 34 by means of a pin 52. An O-ring 54 tightly closes the space between the part 44 of the sleeve 34 and the fixed part 48 of the sealing 38. The rotating part 50 of the sealing 38 includes two rings 56, 58 which carry two O-rings 60, 62. The first O-ring 60 is arranged between the two rings 56, 58 and the second O-ring 62 is arranged between the second ring 58 and the rotating shaft 20. A compression coil spring 64 presses the rotating part 50 of the sealing 38 into a front contact against the fixed part 48. The first ring 56 and the fixed part 58 of the sealing 38 are maintained into a mutual contact therebetween along a sealing front surface 66.

The mechanical sealings of the type above described are standard commercial components which could be replaced by any other sealing type suitable for ensuring the tight closure of the chamber 36.

The chamber 36 containing the sanifying liquid can be insulated from the outer environment. Alternatively, as shown in the figures, the chamber 36 can be equipped with an inlet 68 and an outlet 70 so as to allow a circulation of the sanifying liquid through the chamber 36. The liquid circulation within the chamber 36 can be continuous or can be carried out at defined time intervals for periodically renewing the action of the sanifying liquid.

In the case in which the capping machine has a plurality of closing heads 10, the sanifying liquid can be maintained in circulation through the different closing heads 10 of the capping machine.

With reference to FIGS. 1-3, the head 10 includes a stationery plate 72 forming a screen which divides a capping area 74 placed below the plate 72 from a motion transmission area 76 placed above the plate 72. The piston 12, the motor 30, the movable flange 16 and the belt drive 32 are arranged in the motion transmission area 76. The sleeve 34 is extending through a hole 78 of the stationary plate 72 and is movable with respect to the plate 72 between the lowered position of FIG. 1 and the lifted position of FIG. 2. In the case in which openings 68, 70 for the inlet and the outlet of the sanifying liquid are foreseen, such openings are located in the part of the sleeve 34 extending above the stationary plate 72.

Preferably, a bellows 80 is co-axially arranged outside the sleeve 34. The lower end of the bellows 80 is fixed to the lower end of the sleeve 34. The upper end of the bellows 80 is fixed to the stationary plate 72. The sleeve 80 allows the movement of the sleeve 34 relative to the stationary plate 72 and protects the sanifying zone from powders. The sleeve 80 further avoids the direct exposure of the capping area 74 to the sliding surface between the sleeve 34 and the plate 72, and isolates the capping environment 74 from the outer environment 76.

The closing head according to the present invention can be used for applying screw caps or pressure caps. For the application of screw caps, a combined translation and rotation motion of the cap gripping element 24 is used for screwing caps on containers. For the application of pressure caps, the rotation movement serves for the angular orientation of the caps, while the translation movement serves for the application of caps to containers.

Obviously, without prejudice to the principles of the invention, construction details and embodiments could widely vary with respect to what has been described and shown, without departing from the scope of the invention, as defined by the following claims.

1. Closing head for an automatic capping machine, including:
a support movable along a vertical direction between a lifted position and a lowered position,
a rotating shaft carried by said support, movable together with this latter along said vertical direction and rotatable with respect to the support around a vertical axis, and
a cap gripping member carried at a lower end of said rotating shaft, and
a sleeve fixed with respect to said support and coaxial with respect to the rotating shaft, the sleeve forming around a part of the rotating shaft a sealed chamber containing a sanifying liquid.

2. Closing head according to claim 1, wherein the chamber containing the sanifying liquid is closed by two mechanical sealings.

3. Closing head according to claim 2, wherein each of said mechanical sealings includes a fixed part and a rotating part elastically pressed in mutual contact along a front sealing surface.

4. Closing head according to claim 1, wherein said sleeve extends through a hole of a stationary plate.

5. Closing head according to claim 4, further including a bellows coaxially arranged outside said sleeve and having a lower end fixed to the sleeve and an upper end fixed to said stationary plate.

6. Closing head according to claim 1, wherein the chamber containing the sanifying liquid is connected with two openings for the inlet and the outlet of the sanifying liquid.
